(19) United States
(12) Patent Application Publication
(10) Pub. No.: US 2016/0318361 A1
(43) Pub. Date: Nov. 3, 2016

(54) TRAILER HITCH GROUND CONNECTOR

(71) Applicants: Chris Anderson, Hebron, CT (US); Steve Saltonstall, Colchester, CT (US)

(72) Inventors: Chris Anderson, Hebron, CT (US); Steve Saltonstall, Colchester, CT (US)

(21) Appl. No.: 15/091,190

(22) Filed: Apr. 5, 2016

Related U.S. Application Data
(60) Provisional application No. 62/155,075, filed on Apr. 30, 2015.

(51) Int. Cl. B60D 1/64; H05F 3/02

(52) U.S. Cl. CPC B60D 1/64; H05F 3/02

(57) ABSTRACT

A trailer hitch ground connector apparatus includes a first positive clamping and electrically conductive instrument that has at least one penetrating clamp surface; and a cable operatively electrically connected with the first instrument at a first end of said cable.

### CROSS-REFERENCE RELATED APPLICATIONS

This is a non-provisional and claims the priority under 35 USC §119(e) of U.S. Patent Application Ser. No. 62/155,705 filed Apr. 30, 2015, hereby incorporated by reference in its entirety.

### BACKGROUND

1. Technical Field

The invention relates to towed vehicles and, more particularly, to the electrical connections made at trailer hitches.

2. Discussion of Art

Towed trailers are useful in transporting household goods, auxiliary vehicles, and recreational equipment. Towed trailers may be used at any hours of the day or night. For example, when departing for a fishing trip, it is desirable to be in the boat on the water just around dawn when the fish are biting. This requires driving the boat to the water pre-dawn.

When towing a trailer in darkness, it is desirable both for the tow driver and for following vehicles that the trailer should be lit. Otherwise the bulk of the unlit trailer can obscure the lights of the towing vehicle, causing calamity. For this reason, at the time when a trailer hitch is installed, an electrical harness typically also is installed for providing power from the towing vehicle for lighting the trailer.

However, conventional trailer electrical harnesses present a problem with corrosion of the ground connection. Power and signal connections are made within a watertight gang plug, but also require a good ground to work properly, or at all in some cases. The ground connection typically is made from chassis to chassis, e.g., via the trailer hitch ball or via a grounding wire that is run through the vehicle and trailer wiring harnesses and attached to the trailer via a bolt or screw. Over time, the trailer hitch ball will rust, which will degrade the quality of the ground connection. Or the original ground wire, if the trailer is equipped with one, can chafe, corrode, or break, creating a faulty ground. A poor ground connection will cause power and lights to flicker or to not work at all as the hitch moves on the ball during vehicle travel.

Occasionally, an inexperienced operator will attempt to remedy the corrosion problem by painting the hitch ball. This has the result of completely interrupting the ground connection, rendering the lights inoperable on any trailer mounted to the hitch.

Another conventional approach to trailer hitch ground connectors, is to provide a bolted electrical connection to the vehicle chassis with a wire leading either to a ground prong of a (non-standard) trailer electrical harness, or to a ring terminal that must then be bolted to the trailer chassis. These types of bolt-and-wired ground connections typically rust out at the vehicle end, with the result that vehicle motion causes the bolt to unexpectedly drop out of the rusted hole as the vehicle and trailer proceed down the highway. Understandably, following drivers will be disconcerted by a trailer that “disappears” into the night as its lights go out.

Thus, it would be advantageous to have an apparatus that provides a reliable and durable ground connection at a trailer hitch.

### BRIEF DESCRIPTION

Embodiments of the invention feature a trailer hitch ground connection that is formed by a positive clamp that has at least one penetrating jaw. By “positive” is meant capable of being locked into a clamped position, preferably any arbitrary position within a range of positions. By “penetrating” is meant sufficiently sharp so as to pierce through paint or rust to make clean metal-to-metal contact for a solid ground connection.

Certain exemplary embodiments, as briefly described above, are illustrated by the following figures.

### DRAWINGS

FIG. 1 shows a first embodiment of the invention, in which a spring-clamp pliers is used as a positive penetrating clamp for a ground connection at an end of a ground connector cable.

FIG. 2 shows a second embodiment of the invention, in which spring clamp pliers are provided as positive penetrating clamps at both ends of a ground connector cable.

FIG. 3 shows detail of a spring clamp pliers as shown in FIG. 2.

FIG. 4 shows a third embodiment of the invention, in which screw clamps are provided as positive penetrating clamps at both ends of a ground connector cable.

FIG. 5 shows detail of a screw clamp as shown in FIG. 4.

### DETAILED DESCRIPTION

Referring to FIG. 1, a trailer hitch 10 can be pivotally attached to a vehicle 12 by way of a ball 14 and a chain 16. A cable 18 provides positive electrical connection from the vehicle 12 to the trailer hitch. The hitch 10 and the ball 14 can provide a conventional grounded electrical connection from the trailer back to the vehicle 12. However, according to a first embodiment of the invention, the conventional ground connection can be supplemented by a ground connector cable 20. The ground connector cable 20 is attached to a tongue 22 of the trailer hitch by a bolt 24 (or similar conductive fastener), and is attached to the vehicle 12 by a positive clamping instrument 26, e.g., a spring clamp pliers.

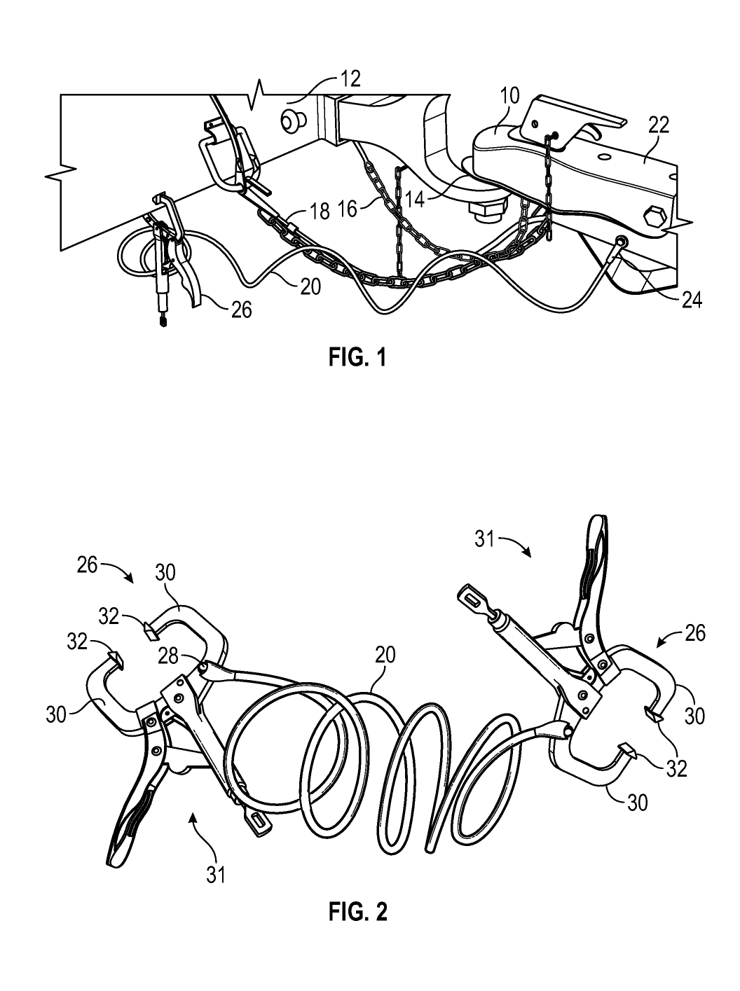

FIG. 2 shows a second embodiment of the invention, in which a positive clamping instrument 26 is operatively electrically connected at each of the ends of the ground connector cable 20. In this view, each positive clamping instrument is a spring clamp pliers. Each spring clamp pliers 26 has jaws 30 that are operable in an adjustable locking manner by conventional handles 31. Each of the jaws 30 has a gripping surface or anvil 32. Referring to FIG. 3, which shows in detail the jaws 30 and anvils 32 of a single spring clamp pliers 26, it can be seen that each anvil 32 is shaped to provide a penetrating edge 34. In use, the spring clamp pliers 26 are locked onto the vehicle 12 or the trailer hitch 10 to provide a solid ground connection via the penetrating edges, despite surface corrosion.

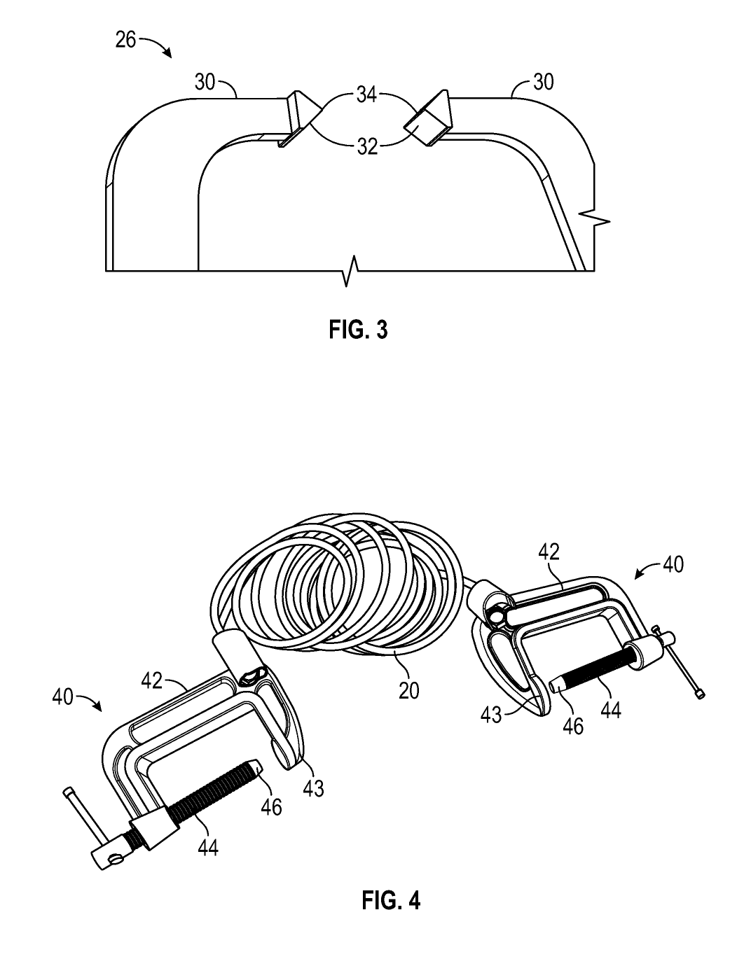

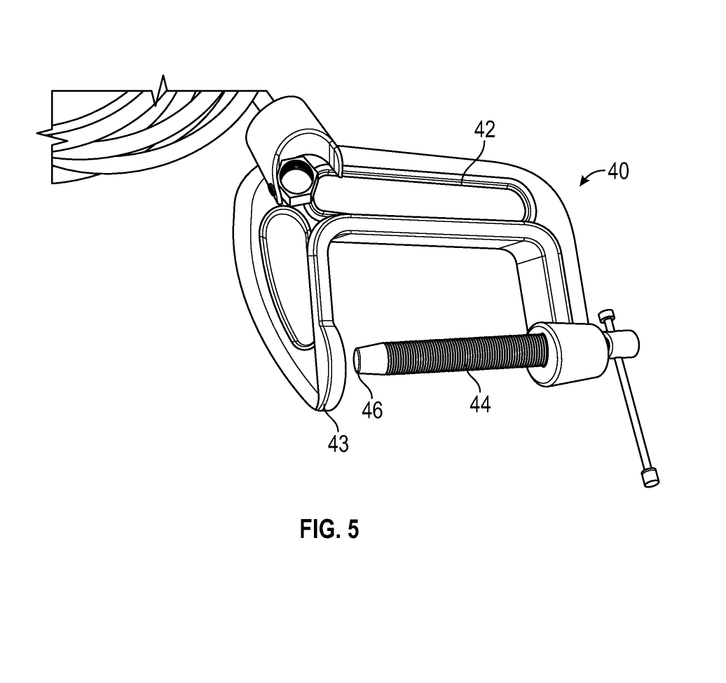

FIG. 4 shows a third embodiment of the invention, by which screw clamps 40 are provided as positive clamping ground connectors. The screw clamps 40 are operatively electrically connected with each other via the grounding connector cable 20. Each of the screw clamps 40 has a body 42, which includes an anvil 43. Each of the screw clamps 40 also includes a screw 44 which is positively adjustable toward the anvil 43. Each screw 44 is sharpened to a penetrating point 46, better shown in FIG. 5. Thus, when in use each clamp 40 is screwed onto a metal structure such as a vehicle bumper or a trailer chassis, the penetrating points 46 pierce through any surface corrosion to obtain a clean metal-to-metal electrical contact at each end of the grounding cable 20.

Although exemplary embodiments of the invention have been described with reference to attached drawings, those skilled in the art nevertheless will apprehend variations in form or detail that are consistent with the scope of the invention as defined by the appended claims.

What is claimed is:

1. A trailer hitch ground connector apparatus comprising:
a first positive clamping and electrically conductive instrument that has at least one penetrating clamp surface; and
a cable operatively electrically connected with the first instrument at a first end of said cable.

2. The apparatus of claim 1 further comprising a second positive clamping and electrically conductive instrument that has at least another penetrating clamp surface and is operatively electrically connected with the cable.

3. The apparatus of claim 1 wherein the first instrument is a spring clamp pliers that has the penetrating clamp surface at the jaw of the pliers.

4. The apparatus of claim 1 wherein the first instrument is a screw clamp that has the penetrating clamp surface at the tip of the screw.

5. The apparatus of claim 1 wherein the second end of the cable carries an electrically conductive threaded fastener.

6. The apparatus of claim 1 wherein the first instrument has the at least one penetrating clamp surface disposed in opposition to an anvil, and the at least one penetrating clamp surface is positively biased toward said anvil by at least one of a cam, a spring, or a screw.

7. The apparatus of claim 6 wherein the anvil is formed with a second penetrating clamp surface.

8. The apparatus of claim 1 wherein the penetrating clamp surface narrows to an edge.

9. The apparatus of claim 1 wherein the penetrating clamp surface narrows to a point.
